(19) United States
(12) Patent Application Publication
(10) Pub. No.: US 2006/0050231 A1
(43) Pub. Date: Mar. 9, 2006

(54) Tinted contact lenses with cell patterns

(76) Inventors: Jack W. Bowers, Jacksonville, FL (US); Karin D. McCarthy, Ponte Vedra Beach, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/922,676

(22) Filed: Aug. 19, 2004

(51) Int. Cl. G02C 7/04

(52) U.S. Cl. 351/162

(57) ABSTRACT

The invention provides tinted contact lenses that include a plurality of cells that serve to enhance or alter the appearance of the wearer's iris. The lens may also incorporates additional elements that overlie a portion of the wearer's iris or limbal region.

### FIELD OF THE INVENTION

The invention relates to tinted contact lenses. In particular, the invention provides contact lenses that either enhance or change the color of a lens wearer's iris.

### BACKGROUND OF THE INVENTION

The use of tinted, or colored, contact lenses to either or both alter the natural color of the iris and to mask ophthalmic abnormalities is well known. Typically, these lenses use either or both opaque and translucent colors to change the color of an iris, as for example, from brown to blue. Additionally, tinted lenses have been manufactured that attempt to enhance the color of a dark-eyed person without changing the color of the iris. These lenses are disadvantageous because either the color enhancement is too subtle to be noticed when the lens is on-eye or the enhancement lends an unnatural appearance to the wearer's iris

### BRIEF DESCRIPTION OF THE DRAWINGS

FIG. 1 is one embodiment of the invention.

FIG. 1a is a magnified view of a portion of FIG. 1.

FIG. 2 is a second embodiment of the invention.

FIG. 3 is a third embodiment of the invention.

### DETAILED DESCRIPTION OF THE INVENTION AND PREFERRED EMBODIMENTS

The invention provides tinted contact lenses, and methods for their manufacture, that enhance the lens wearer's iris. The lenses of the invention have a pattern made of a plurality cells that serves to enhance the definition of the wearer's iris resulting in the iris appearing larger to viewer's of the lens wearer. Alternatively, the pattern may be used to alter the color of the wearer's iris. The lenses of the invention may find greatest utility as cosmetic lenses for enhancing or altering a dark-eyed individual's iris, but also may be used to enhance or alter the iris of a light-eyed lens wearer as well.

In one embodiment, the invention provides a contact lens comprising, consisting essentially of, and consisting of a plurality of cells. For purposes of the invention, by “cell” is meant a structure that partially or fully encloses a space.

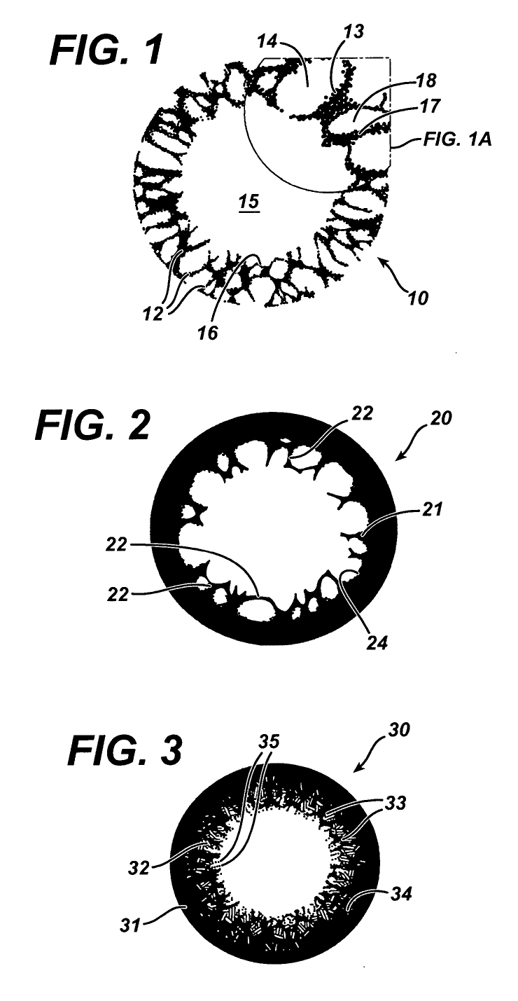

In FIG. 1 is shown one embodiment of a cell pattern 10. In this embodiment, a plurality of randomly arranged cells, such as 12, substantially compose the iris portion of the lens, or portion of the lens that overlies the wearer's iris while the lens is on-eye and centered. The cells may fully or, preferably, partially compose the iris portion. The innermost border 16 of the cell pattern is at a diameter of about 7 mm from the geometric center of the lens. However, the innermost border may be from about 5 to about 8 mm from the geometric center of the lens. Innermost border 16 as shown is of an even, regular shape, but may be an uneven, irregular border. Area 15 is a region in which there are no pattern elements, which area as shown, will partially compose the iris portion as well as the whole of the pupil portion, or portion of the lens that overlies the wearer's pupil while the lens is on-eye and centered. As shown, area 11 is clear, but it may be translucently or opaquely colored as well.

FIG. 1a is a magnified view of a portion of the cell pattern in which is shown individual cell 13. As shown, cell 13 almost completely encloses space 14. Also shown is cell 17 enclosing space 18. The shape and size of cells 13 and 17, as shown, and preferably, are different. However, all cells in a cell pattern may be of either or both the same size and shape. The cells shown in both FIGS. 1 and 1a are composed of dots, which dots may be of any size and preferably are about 0.060 to about 0.180 mm in diameter, more preferably about 0.0075 to about 0.0125 mm in diameter. Alternatively, cells of the invention may be made from any alternative component to dots including, without limitation, lines, non-geometric shaped components or the like and combinations thereof or a combination of dots and one or more of the alternative components.

The cells may be combined with any number of additional elements to form more elaborate patterns. Such components may include, without limitation, limbal rings, geometric structures, such as dots and lines, or fanciful structures including, without limitation, striae or feather-like structures. In one preferred embodiment, the cells are combined with a limbal ring and the invention provides a contact lens comprising, consisting essentially of, and consisting of a limbal ring and a plurality of cells.

By “limbal ring” is meant an annular band of color that, when the lens is on-eye and centered, partially or substantially completely overlies the lens wearer's limbal region, or the junction of the sclera with the cornea. Preferably, the limbal ring substantially completely overlies the limbal region. The innermost border, or edge closest to the geometric center of the lens, of the limbal ring may be at a diameter of about 8 mm to about 12 mm, preferably about 9 to about 11 mm, from the lens' geometric center. The ring may be of any suitable width and preferably is about 0.5 to about 2.5 mm in width, more preferably about 0.75 to about 1.25 mm in width.

As shown in FIG. 2, cell pattern 20 includes a limbal ring 21. Beginning at the innermost border 24 of limbal ring 21 are a plurality of cells 22. The cells shown compose only a portion of the iris portion of the lens, but in this or any design of the invention, although less preferred, the cells may compose the entire iris portion. As shown, the innermost border 24 of limbal ring 21 is an uneven, irregular border, but may be even.

Yet another alternative embodiment, in which the cells are combined with more than one additional element, is depicted in FIG. 3. In FIG. 3 is shown limbal ring 31, cells 33, and hatch marks 32. By “hatch mark” is meant a grouping of two or more parallel lines. The individual lines that make up the hatch marks may be of uniform or varying width, lengths, and spacing. Each line within the hatch mark preferably is a substantially straight line, but may be other than straight. Additionally shown is a plurality of dots 35. Preferably, dots 35 and hatch marks 32 are located within the enclosed spaces of the cells 33.

The color selected for each of the cells, limbal ring and remaining pattern elements will be determined by the natural color of the lens wearer's iris and the enhancement or color change desired. Each of the cells, limbal rings and additional elements may be of the same or of complementary colors. Thus, elements may be any color including, without limitation, any of a variety of hues and chromas of blue, green, gray, brown, black yellow, red, or combinations thereof. Preferred colors for the limbal ring include, without limitation, any of the various hues and chromas of black, brown and gray.

As used in a lens for either enhancing or altering the wearer's eye color, preferably the limbal ring element is a solid band of color that masks the color of the lens wearer's limbal region and more preferably the masking color is an opaque color. The remaining elements, the cells and other pattern elements, may be translucent or opaque depending on the desired on-eye result. For purposes of the invention, by “translucent” is meant a color that permits an average light transmittance (% T) in the 380 to 780 nm range of about 60 to about 99%, preferably about 65 to about 85% T. By “opaque” is meant a color that permits an average light transmittance (% T) in the 380 to 780 nm range of 0 to about 55, preferably 7 to about 50% T.

The elements, may be made from any organic or inorganic pigment suitable for use in contact lenses, or combinations of such pigments. The opacity may be controlled by varying the concentration of the pigment and titanium dioxide used, with higher amounts yielding greater opacity. Illustrative organic pigments include, without limitation, pthalocyanine blue, pthalocyanine green, carbazole violet, vat orange # 1, and the like and combinations thereof. Examples of useful inorganic pigments include, without limitation, iron oxide black, iron oxide brown, iron oxide yellow, iron oxide red, titanium dioxide, and the like, and combinations thereof. In addition to these pigments, soluble and non-soluble dyes may be used including, without limitation, dichlorotriazine and vinyl sulfone-based dyes. Useful dyes and pigments are commercially available.

The dye or pigment selected may be combined with one or more of a pre-polymer, or binding polymer, and a solvent to form the colorant used to produce the translucent and opaque layers used in the lenses of the invention. Other additives useful in contact lens colorants also may be used. The binding polymers, solvents, and other additives useful in the color layers of the invention are known and either commercially available or methods for their making are known.

The elements may be applied to, or printed on, one or more surfaces of a lens or may be printed onto one or more surfaces of a mold into which a lens forming material will be deposited and cured. In a preferred method for forming lenses incorporating the designs of the invention, a thermoplastic optical mold, made from any suitable material including, without limitation, cyclic polyolefins and polyolefins such as polypropylene or polystyrene resin is used. The elements are deposited onto the desired portion of the molding surface of the mold. By “molding surface” is meant the surface of a mold or mold half used to form a surface of a lens. Preferably, the deposition is carried out by pad printing as follows.

A metal plate, preferably made from steel and more preferably from stainless steel, is covered with a photo resist material that is capable of becoming water insoluble once cured. The elements are selected or designed and then reduced to the desired size using any of a number of techniques such as photographic techniques, placed over the metal plate, and the photo resist material is cured.

The plate is subsequently washed with an aqueous solution and the resulting image is etched into the plate to a suitable depth, for example about 20 microns. A colorant containing a binding polymer, solvent, and pigment or dye is then deposited onto the elements to fill the depressions with colorant. A silicon pad of a geometry suitable for use in printing on the surface and varying hardness, generally about 1 to about 10, is pressed against the image on the plate to remove the colorant and the colorant is then dried slightly by evaporation of the solvent. The pad is then pressed against the molding surface of an optical mold. The mold is degassed for up to 12 hours to remove excess solvents and oxygen after which the mold is filled with lens material. A complementary mold half is then used to complete the mold assembly and the mold assembly is exposed to conditions suitable to cure the lens material used. Such conditions are well known in the art and will depend upon the lens material selected. Once curing is completed and the lens is released from the mold, it is equilibrated in a buffered saline solution.

In a preferred embodiment, a clear, pre-polymer layer is used, which pre-polymer layer overlays at least the limbal ring and cell elements and preferably forms the entirety of the lens' outermost surface. The pre-polymer may be any polymer that is capable of dispersing the pigment and any opacifying agent used.

The invention may be used to provide tinted hard or soft contact lenses made of any known lens-forming material, or material suitable for manufacturing such lenses. Preferably, the lenses of the invention are soft contact lenses, the material selected for forming the lenses of the invention being any material suitable for producing soft contact lenses. Suitable preferred materials for forming soft contact lenses using the method of the invention include, without limitation, silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof. More preferably, the lens material contains a siloxane functionality, including, without limitation, polydimethyl siloxane macromers, methacryloxypropyl polyalkyl siloxanes, and mixtures thereof, a silicone hydrogel or a hydrogel, made of monomers containing hydroxy groups, carboxyl groups, or both or combinations thereof. Materials for making soft contact lenses are well known and commercially available. Preferably, the material is acquafilcon, etafilcon, genfilcon, lenefilcon, balafilcon, lotrafilcon, or galyfilcon.

1. A contact lens, comprising a pattern comprising a web of a plurality of randomly arranged cells, each of the cells comprising a space with a wall extending partially or fully therearound, the wall comprising one or more colored elements.

2. The contact lens of claim 1, further comprising a limbal ring.

3. The lens of claim 1, wherein each wall of each of the plurality of cells comprises a plurality of dots.

4. The lens of claim 2, wherein each wall of each of the plurality of cells comprises a plurality of dots.

5. The lens of claim 1, further comprising one or more additional elements selected from the group consisting of dots, hatch marks, and fanciful structures.

6. The lens of claim 2, further comprising one or more additional elements selected from the group consisting of dots, hatch marks, and fanciful structures.

7. A method of enhancing an iris, comprising providing a contact lens comprising a pattern comprising a web of a plurality of randomly arranged cells, each of the cells comprising a space with a wall extending partially or fully therearound, the wall comprising one or more colored elements.

8. A method of enhancing an iris, comprising providing a contact lens comprising (a.) a pattern comprising a web of a plurality of randomly arranged cells, each of the cells comprising a space with a wall extending partially or fully therearound, the wall comprising one or more colored elements and (b.) a limbal ring.

9. The lens of claim 1, wherein each wall of each of the plurality of cells comprises one or more lines.

10. The lens of claim 2, wherein each wall of each of the plurality of cells comprises one or more lines.

11. The lens of claim 1, wherein each wall of each of the plurality of cells comprises one or more or non-geometric components.

12. The lens of claim 2, wherein each wall of each of the plurality of cells comprises one or more or non-geometric components.

13. The lens of claim 3, further comprising one or more additional elements selected from the group consisting of dots, hatch marks, and fanciful structures.

14. The lens of claim 4, further comprising one or more additional elements selected from the group consisting of dots, hatch marks, and fanciful structures.

15. The lens of claim 9, further comprising one or more additional elements selected from the group consisting of dots, hatch marks, and fanciful structures.

16. The lens of claim 10, further comprising one or more additional elements selected from the group consisting of dots, hatch marks, and fanciful structures.

17. The lens of claim 11, further comprising one or more additional elements selected from the group consisting of dots, hatch marks, and fanciful structures.

18. The lens of claim 12, further comprising one or more additional elements selected from the group consisting of dots, hatch marks, and fanciful structures.
